(19) United States
(12) Patent Application Publication
(10) Pub. No.: US 2008/0002940 A1
(43) Pub. Date: Jan. 3, 2008

(54) Video recording/reproducing apparatus and video recording/reproducing method

(75) Inventor: Tomohiko Tsunoda, Tokyo (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/812,934

(22) Filed: Jun. 22, 2007

(30) Foreign Application Priority Data
Jun. 30, 2006 (JP) 2006-182333

(51) Int. Cl. H04N 5/91

(52) U.S. Cl. 386/46; 386/E05.042

(57) ABSTRACT

According to one embodiment, a video recording/reproducing apparatus comprises a receiver that receives programs, and a storing unit that, when a program received by the receiver is recorded in an HDD, and if the name of the program to be recorded contains a letter string identical with the letter string of the name of a recorded program, stores the to-be-recorded program and recorded program in a common folder.

### CROSS-REFERENCE TO RELATED APPLICATIONS

This application is based upon and claims the benefit of priority from Japanese Patent Application No. 2006-182333, filed Jun. 30, 2006, the entire contents of which are incorporated herein by reference.

### BACKGROUND

1. Field

One embodiment of the invention relates to a video recording/reproducing apparatus that receives broadcast programs and has a folder function for storing programs relating to one another into a common folder, for example, and a video recording/reproducing method.

2. Description of the Related Art

Recently, with a drastic increase in memory capacity in information recording media such as hard disk drives (HDDs), a great number of TV programs can be recorded. For reservation of the recording of the programs, principally used were a method in which a user designates a broadcast date, channel, start time, and end time of a desired program and a method in which a user enters the G code written on a program table. In recent, however, with increase in penetration of digital broadcasting, apparatuses capable of performing recording reservation using an electronic program table referred to as Electronic Program Guide (EPG) have been becoming pervasive.

If there are a multitude of programs recorded, particularly a drama series which is broadcast every day and stored for several days, but not yet viewed i.e, played back, it takes a lot of time and trouble to find a certain episode that the user wants to view. Further, if the recorded programs are to be dubbed (transferred) onto another device, it is also hard to find the relevant recorded program. This holds true with music programs other than drama series which the user views every week and stores in the HDD as they are.

There exist apparatuses that overcome the drawbacks of such recording/reproducing apparatuses as described above by storing programs relating to one another in a common folder, with facilitation in the management of the recorded programs. In such apparatuses, for example, programs in the same category are grouped and stored in a recording medium. In Jpn. Pat. Appln. Publication No. 2005-286388, there is disclosed an apparatus which groups at least one program so as to identify the program as the same group by the attribution of the program, and therewith presents a group program table.

In the above publication, however, the user must create folders to store recorded programs, which requires labor and time. In addition, when the user records a multitude of different programs before transferring each of the relating programs into a corresponding folder, he or she is required to find the relevant programs before transferring them into the corresponding folders with labor and time.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing a structure of a video recording/reproducing apparatus 10 to which the present invention is applied;

FIG. 2 is a flowchart of the setting of conditions of storing a program in a folder;

FIG. 3 is a view showing an example of conditional setting menu for automatic classification according to the present invention;

FIG. 4 is a view showing an embodiment of a reservation list according to the present invention;

FIG. 5 is a flowchart showing an operation sequence when a reserved program is recorded;

FIG. 6 is a flowchart showing a second embodiment of an operation sequence of recording a reserved program;

FIG. 7 is a flowchart showing an embodiment of an operation sequence of automatic classification for recorded programs;

FIG. 8 is a view showing an example of a list of recorded programs according to the present invention;

FIG. 9 is a view showing an example of execution confirmation screen for automatic classification processing according to the present invention; and

FIG. 10 is a view showing an example of a recording list showing programs which have been automatically classified according to the present invention.

### DETAILED DESCRIPTION

Various embodiments according to the invention will be described hereinafter with reference to the accompanying drawings. In general, according to one embodiment of the invention, a video recording/reproducing apparatus comprises a receiver that receives programs, and a storing unit (19, Block 203) that, when a program received by the receiver is recorded in an HDD, and if the name of the program to be recorded contains a letter string identical with the letter string of the name of a recorded program (Block 201, yes), stores the to-be-recorded program and recorded program in a common folder.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

Hereinafter, embodiments of the present invention will be described with reference to the accompanying drawings.

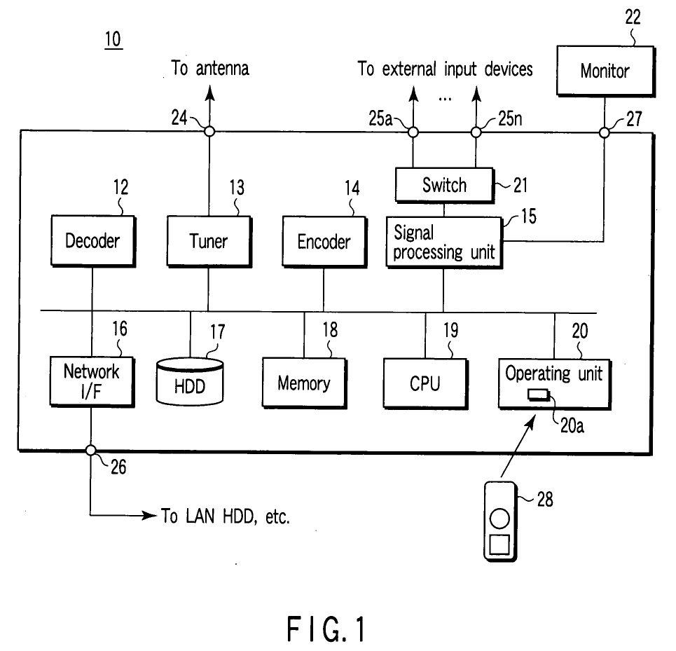

FIG. 1 is a block diagram showing a structure of a video recording/reproducing apparatus 10 to which the present invention is applied. The apparatus 10 is applicable to various video recording/reproducing apparatuses such as TV receivers with built-in HDD, DVD recorders, personal computers, etc.

A tuner 13 receives broadcast signals received by an antenna via an antenna input terminal 24. The tuner 13 extracts program data of specific channels from the received broadcast signals. The tuner 13 is a digital tuner that is capable of receiving digital broadcasting such as BS digital broadcasts and digital terrestrial broadcasts.

A network interface 16 interfaces with equipment on the network connected via a network terminal 26. Such equipment on the network includes a Local Area Network Hard Disk Drive (LAN HDD) unit. The LAN HDD is a technical specification for using an AV device with built-in HDD, a personal computer, and the like, in cooperation with each other on a household LAN.

A decoder 12 decodes (decompresses) compressed data supplied from the tuner 13, network interface 16 or an HDD 17. The HDD 17 records encoded video and audio data supplied from the tuner 13, network interface 16 or an encoder 14.

A signal processing unit 15, for example, performs D/A (digital-analog) conversion and amplification on the video and audio data decoded by the decoder 12, thereby reproducing video and audio signals. A monitor 22 displays video based on the video signal and outputs audio based on the audio signal both supplied from the signal processing unit 15 via a terminal 27. The monitor 22 may be configured to be contained in the video recording/reproducing apparatus or configured to be externally connected to the apparatus through a cable.

A switching unit 21 selects one of the external input devices connected thereto via external input terminals 25a, . . . , 25n under the control of a CPU 19 and supplies the signal processing unit 15 with an analog signal from a selected external input device. The signal processing unit 15 carries out signal processing including amplification and filtering on the analog signal input from the external input device, and supplies the monitor 22 with the processed signal. In the case where the analog signal from the external input device is recorded, the relevant analog signal is, for example, A/D (analog-digital)-converted by the signal processing unit 15 and encoded by the encoder 14, and then recorded in the HDD 17.

An operating unit 20 is a user interface which has various buttons for receiving various input operations from a user, and a receiver 20a for receiving signals transmitted from a remote controller 28. The user operates the video recording/reproducing apparatus 10 using the operating unit 20 and remote controller 28.

A memory 18 includes a ROM storing various control programs and a RAM used as a work area of the CPU 19. The CPU 19 executes the control programs recorded in the memory 18 in accordance with an instruction input from the user via the operating unit 20.

Next, explanation will be given of an embodiment of automatic classification recording of programs according to the present invention.

In this embodiment, when a program received by the tuner 13 is recorded in the HDD 17, if the name of the program to be recorded contains a letter string identical with that of a recorded program, the to-be-recorded program and the recorded program are both stored as programs having identical names, in a common folder in the HDD 17. The program name can be readily determined by reference to the EPG.

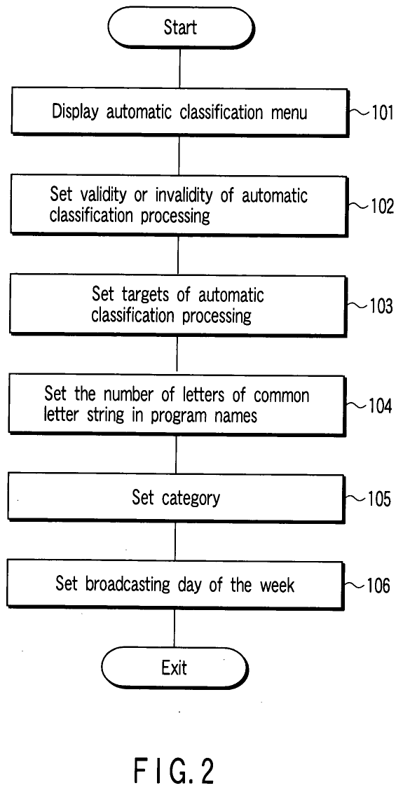

FIG. 2 is a flowchart of the setting of conditions for storing a program in a folder, i.e., conditions for determining that a to-be-recorded program is identical with a certain recorded program. This conditional setting can be carried out as the initial setting of the apparatus, or carried out when a program recording is reserved. Alternatively, the conditional setting can be carried out when a multitude of recorded programs are automatically classified by using folders, as will be described later.

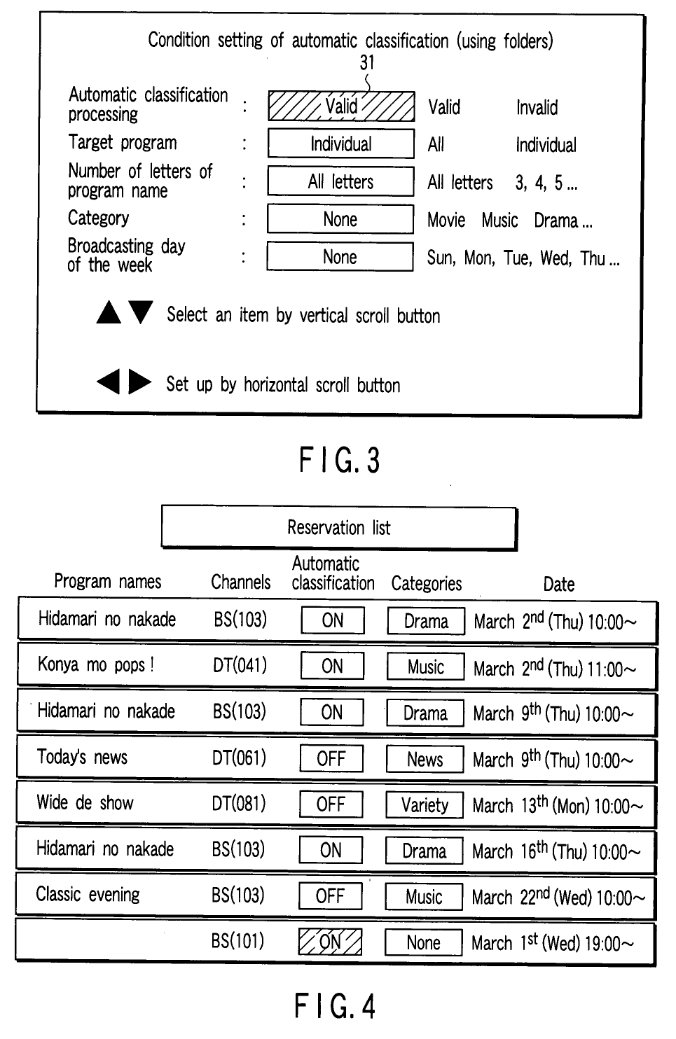

First, the CPU 19 displays on the monitor 22 a conditional setting menu for automatic classification as shown in FIG. 3 (Block 101). For example, a cursor 31 is moved up and down using vertical scroll buttons of the remote controller 28, and the contents of individual items are set using horizontal scroll buttons.

In response to an instruction from the user which is input from the remote controller 28 or the like, the CPU 19 sets the validity or invalidity of automatic classification processing, that is, a process of storing, in a common folder, programs containing identical letter strings in the names, and a target program for automatic classification processing (Block 102, S103). The setting of a target program for automatic classification process can be selected from “all” and “individual”. In the case of “individual” being selected, whether or not the relevant program should be automatically classified can be determined on an individual basis, for example, at the time of a recording reservation, as will be described later.

At Block 104, the number of letters of the common letter string contained in the program name is set. The setting of the number of letters includes also the setting of all letters of the program name. At Block 105, a category of the program is set. The categories include movie, music, drama, and the like. At Block 106, a broadcasting day of the week of the program is set.

Now, explanation will be given of the individual setting of automatic classification processing. FIG. 4 is a view showing an embodiment of a reservation list according to the present invention.

For the reservation of program recording by the user, the CPU 19 displays a reservation list of FIG. 4 on the monitor 22, on the instruction of the user. The reservation list represents program names, broadcast channels, ON/OFF of automatic classification, categories, and broadcasting times and dates about the individual programs reserved for recording. “BS” indicates BS digital broadcasts, and “DT” indicates digital terrestrial broadcasts. The user can set the content of each item by a remote controller or the like. Incidentally, each program name is automatically set by the CPU 19 with reference to the EPG, based on the broadcast channel and broadcasting time and date.

The ON/OFF of the automatic classification indicates whether or not an automatic classification recording of a program, that is, a process of storing, in a common folder, programs containing identical letter strings in the program names should be executed. If the item is set ON, the CPU 19 executes an automatic classification recording of the reserved program at the time of the recording of the relevant program. As described above, in this embodiment, the user can determine about each program to be recorded whether or not the automatic classification should be executed thereon.

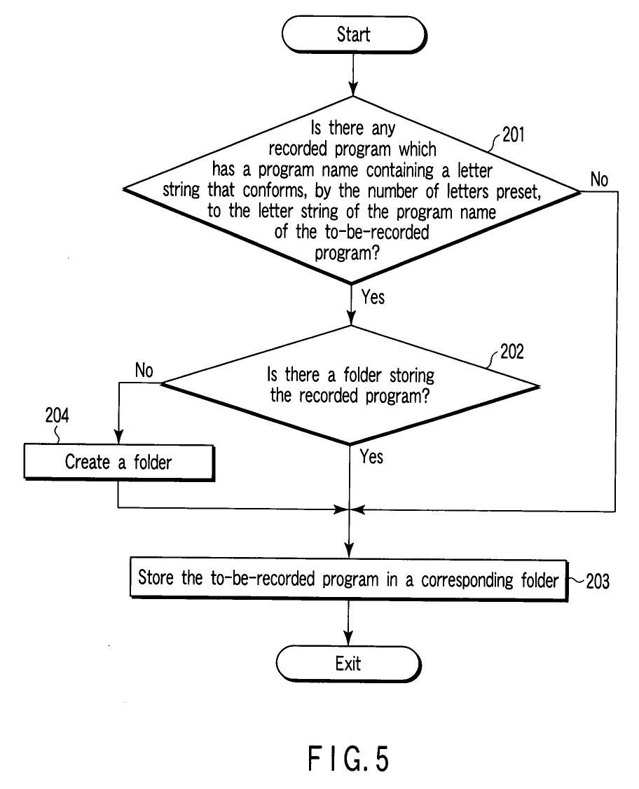

Next, an example of recording operation will be explained. FIG. 5 is a flowchart showing an operation sequence when a reserved program is recorded.

When recording a reserved program, the CPU 19 determines whether or not there is any recorded program which has a program name containing a letter string that conforms to the letter string of the program name of the to-be-recorded program, for example, by the number of letters preset in such a manner as in Block 104 of FIG. 2 (Block 201). If there is a relevant recorded program (Block 201, YES), the CPU 19 determines whether a folder storing the relevant recorded program exists (Block 202).

If there is a folder storing such recorded program (Block 202, YES), the CPU 19 stores the to-be-recorded program in the relevant folder (Block 203). On the other hand, if there is no folder storing such recorded program (Block 202, NO), the CPU 19 creates a folder and stores in the created folder the to-be-recorded program and the aforementioned recorded program having a program name containing a letter string that conforms, by the number of letters preset, to the letter string of the program name of the to-be-recorded program (Block 203). In this manner, the CPU 19 newly creates a folder if there exists no folder for storing the to-be-recorded program and such a recorded program as mentioned above.

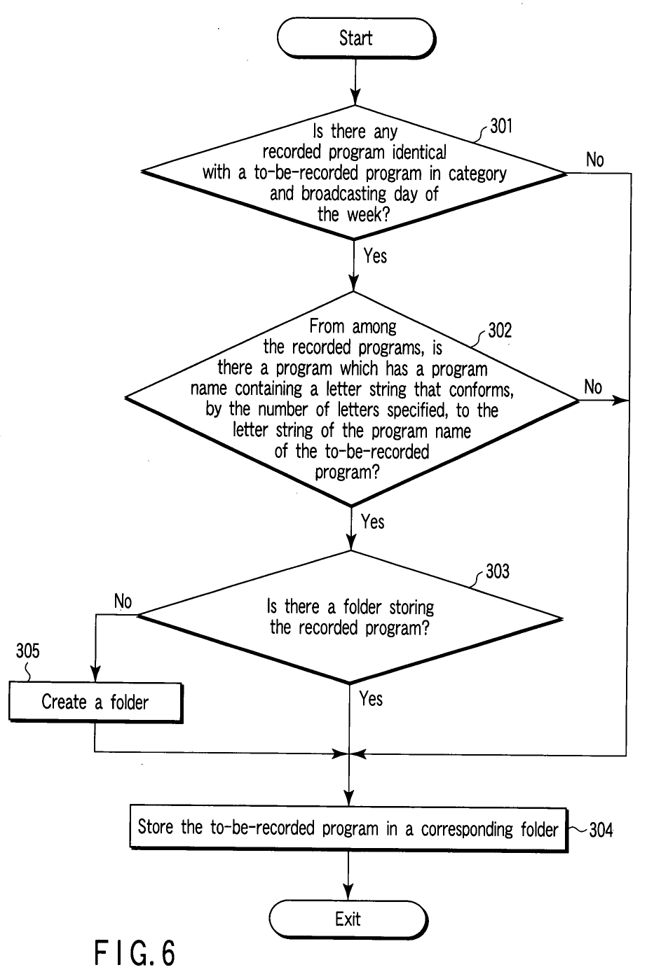

FIG. 6 is a flowchart showing a second embodiment of an operation sequence of recording a reserved program.

In the second embodiment, as the conditions for storing a program in a folder, in addition to the conditions in the above embodiment of FIG. 5, when a program category and a broadcasting day of the week (or a broadcast start time) of a to-be-recorded program and those of the recorded program are identical with each other, the to-be-recorded program and the recorded program are stored in a common folder.

The CPU 19 first determines whether or not there is any recorded program identical with the to-be-recorded program in category and broadcasting day of the week (or broadcast start time) (Block 301). If there are some corresponding recorded programs (Block 301, YES), the CPU 19 determines from among the relevant recorded programs whether or not there is a program having a program name containing a letter string that conforms, by the number of letters preset, to the letter string of the program name of the to-be-recorded program (Block 302). If there is a corresponding recorded program (Block 302, YES), the CPU 19 determines whether there exists a folder storing such recorded program (Block 303).

If there exists a folder storing such recorded program (Block 303, YES), the CPU 19 stores the to-be-recorded program in the relevant folder (Block 304). On the other hand, if there exists no folder storing such recorded program (Block 303, NO), the CPU 19 newly creates a folder and stores in the created folder the to-be-recorded program and the recorded program having a program name containing a letter string that conforms to the letter string of the program name of the to-be-recorded program by the number of letters which have been preset in the aforementioned manner (Block 304).

Additionally, if there is no recorded program having a program name containing an identical letter string (Block 302, NO), the CPU 19 stores programs of the same category and broadcasting day of the week in a common folder. In this way, programs identical with one another not only in category but also in broadcasting day of the week are stored in a common folder. Thus, the identification of the recorded programs can be made easier. Further, it is also possible to store, in a common folder, programs which are identical with one another in at least one, two, or all of program category, broadcasting day of the week and broadcast start time.

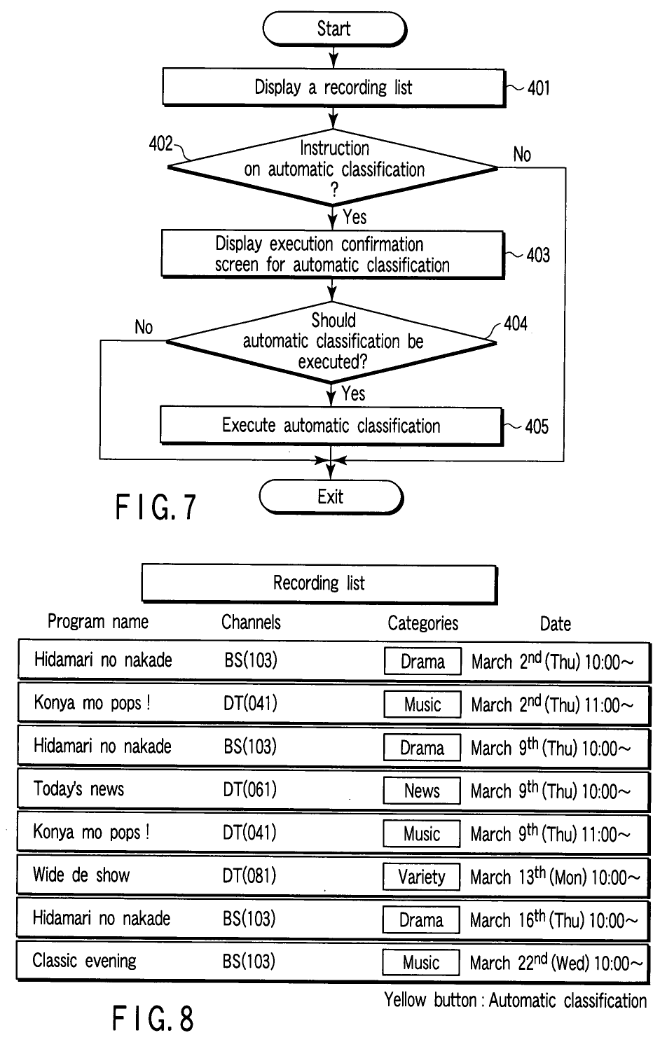

Now, explanation will be given of batch automatic classification of recorded programs. FIG. 7 is a flowchart showing an embodiment of an operation sequence of batch automatic classification for recorded program. In this embodiment, each of multiple recorded programs which contain identical letter strings in program names is stored in a common folder. Meanwhile, in this embodiment, the setting of automatic classification as shown in the embodiment of FIG. 4 is not made for individual programs at the time of program reservation.

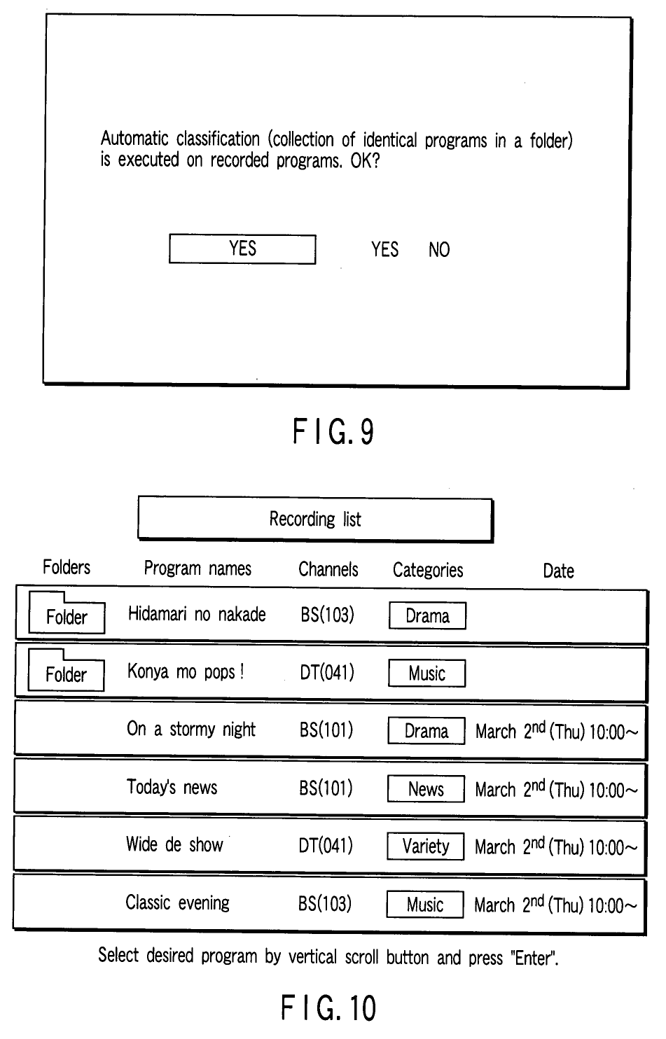

Upon user's instruction on automatic classification of recorded programs by means of a remote controller or the like, the CPU 19 displays on the monitor 22 such a recording list (a list of recorded programs) as shown in FIG. 8 (Block 401). Here, if the user instructs the CPU 19 on the automatic classification of recorded programs, for example, by a push on a yellow button (Block 402, YES), the CPU 19 displays on the monitor 22 an execution confirmation screen for automatic classification processing as shown in FIG. 9.

With the display of the execution confirmation screen, if the user enters “YES”, the CPU 19 executes the automatic classification of the recorded programs (Block 405). As a result, the recording list of FIG. 8 changes itself to a recording list after the automatic classification as shown in FIG. 10. In this automatic classification, three identical recorded programs with a common program name “Hidamari no nakade” shown in FIG. 8 are stored in one folder, and two identical recorded programs with a common program name “Konya mo Pops” are stored in another folder.

As has been described, according to the embodiments of the present invention, the recorded programs with the same program name can be stored in one folder through the automatic classification, whereby a target recorded program can be easily found. This is advantageous particularly for programs such as drama series because the user can instantly find a certain episode (date) thereof which the user wants to view. Further, drama series and programs which are recorded every week are stored all on a folder basis, thus rendering a list of recorded programs in order and viewable. Accordingly, recorded programs stored out of folder also can be easily found.

Additionally, the programs to be recorded are not restrictive to the digital broadcast programs received by the tuner 13. It is apparent that the present invention can be applied also to video contents from the devices such as LAN HDD and the like received via the network I/F 16.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A video recording and reproducing apparatus comprising:
a receiving portion which receives programs; and
a storing portion which, when a program received by the receiving portion is recorded, and if the name of the program to be recorded contains a letter string identical with the letter string of the name of a recorded program, stores the to-be-recorded program and recorded program in a common folder.

2. The video recording and reproducing apparatus according to claim 1, further comprising: a setting portion which sets, as a condition for storing a program in the folder, the number of letters of the identical letter string, wherein the storing portion stores in a common folder the to-be-recorded program and recorded program having a program name containing a letter string that conforms, by the number of letters preset, to the letter string of the program name of the to-be-recorded program.

3. The video recording and reproducing apparatus according to claim 1, further comprising: a setting portion which, as a condition for storing a program in the folder, sets that the whole letter string of the program name is identical in the to-be-recorded program and the recorded program, wherein the storing portion stores in a common folder the to-be-recorded program and the recorded program having a program name identical with the program name of the to-be-recorded program.

4. The video recording and reproducing apparatus according to claim 1, further comprising:
a portion which creates a folder if there exists no folder for storing the to-be-recorded program and the recorded program.

5. The video recording and reproducing apparatus according to claim 2, further comprising:
a portion which creates a folder if there exists no folder for storing the to-be-recorded program and the recorded program.

6. The video recording and reproducing apparatus according to claim 2, wherein
the setting portion sets, as the condition for storing a program, that at least one of category, broadcasting day of the week and broadcast start time of the to-be-recorded program is identical with those of the recorded program.

7. The video recording and reproducing apparatus according to claim 1, further comprising:
a portion which sets whether or not a process of storing in a common folder the programs containing identical letter strings in the program names is executed.

8. The video recording and reproducing apparatus according to claim 1, wherein
the storing portion stores in a common folder each of multiple recorded programs which contain identical letter strings in the program names.

9. The video recording and reproducing apparatus according to claim 1, wherein
the receiving portion is a network interface which receives video contents from a server connected via a network.

10. A video recording and reproducing method comprising:
receiving a program containing video contents; and
storing, when the received program is recorded, and if the name of the program to be recorded contains a letter string identical with the letter string of the name of a recorded program, the to-be-recorded program and recorded program in a common folder.
